(19) United States
(12) Patent Application Publication
(10) Pub. No.: US 2002/0196001 A1
(43) Pub. Date: Dec. 26, 2002

(54) Electrical system architecture for a motor vehicle

(76) Inventor: Johann Egon Morgen, Pfakofen (DE)

Correspondence Address: LERNER AND GREENBERG, P.A., POST OFFICE BOX 2480, HOLLYWOOD, FL, 33022-2480, US

(21) Appl. No.: 10/177,677

(22) Filed: Jun. 20, 2002

(30) Foreign Application Priority Data
Jun. 20, 2001 (DE) 101 29 789.0

(51) Int. Cl. H02H 7/06; H02P 9/00

(52) U.S. Cl. 322/17

(57) ABSTRACT

An electrical system architecture for a motor vehicle is described. The system architecture has a generator outputting a high AC voltage and at least one low AC voltage and a voltage processing unit for generating a high DC voltage from the high AC voltage. A coupling device is provided for coupling the low AC voltage to the high DC voltage. A high voltage line is provided, which is fed by the coupling device, and to which the high DC voltage with the superimposed low AC voltage is applied.

### BACKGROUND OF THE INVENTION

1. Field of the Invention

The invention relates to an electrical system architecture for a motor vehicle having a generator for a high AC voltage and at least one low AC voltage and a rectifier for generating a high DC voltage from the high AC voltage.

Such a vehicle electrical system architecture has been proposed by T. Jahns in MIT/Industry Consortium Meeting in June 1998 under the title “Comparative Architecture Evaluation”. However, as, apart from the high DC voltage of approximately 42V, the previous voltage of approximately 14V and in addition a low voltage of approximately 7V for operating electrical control devices and sensors which require operating voltages of approximately 5V or 3.3V is disclosed. In a future motor vehicle electrical system, it will be necessary to acquire these voltages in some way and conduct them to the respective loads.

The architecture comparison of T. Jahns proposes that only an AC/DC converter should be added to the generator and the high DC voltage of 42V should be conducted to the loads in the motor vehicle on only one line. Respective DC/DC converters that generate a low DC voltage of 14V are to be then provided only at the loads. This principle could also be applied with 5V loads, but this would lead to a high power loss in the linear controllers so that, owing to the temperature increase in the components that is associated with this, it cannot be realized without considerable additional costs. In addition, a considerable number of such DC/DC converters is necessary, which also leads to an increase in costs. Further concepts provide for the low voltage of 14V to be generated directly during the rectification of the generated DC voltage of 42V or to be generated by a large DC/DC converter which is disposed downstream of the rectifier. However, two line networks are necessary for the 42V and the 14V here. When the known architecture is applied to a vehicle electrical system with the need for an additional 7V, a further third line network would be necessary, which would lead to considerable additional costs.

### SUMMARY OF THE INVENTION

It is accordingly an object of the invention to provide an electrical system architecture for a motor vehicle that overcomes the above-mentioned disadvantages of the prior art devices of this general type, which provides a high voltage and a low voltage, and requires only one line network and gives rise to only low additional costs.

With the foregoing and other objects in view there is provided, in accordance with the invention, in a motor vehicle, an electrical system architecture. The electrical system architecture contains a generator outputting a high AC voltage and at least one low AC voltage being lower than the high AC voltage. A voltage processing unit is connected to the generator and generates a high DC voltage from the high AC voltage. A coupling device is connected to the voltage processing unit and couples the low AC voltage to the high DC voltage. A high voltage line extends from and is fed by the coupling device. The high voltage line carries the high DC voltage with the low AC voltage superimposed therewith.

According to the invention, the electrical system architecture of the generic type therefore has a coupling device for coupling the low AC voltage to the high DC voltage and a high voltage line which is fed by the coupling device and to which the high DC voltage with the superimposed low AC voltage is applied. The superimposed AC voltage can be extracted and rectified in any load that is intended to operate with this voltage, in particular in controllers or sensors. In this way, conventional linear controllers can be maintained.

In a development according to the invention, the vehicle electrical system architecture contains at least one decoupling device that is connected to the high voltage line, is formed with a rectifier circuit and decouples the low AC voltage superimposed on the high DC voltage from the voltage on the high voltage line, and rectifies it.

By such a pure 42V architecture, up to 12 DC/DC converters can be dispensed with compared with the prior art according to contemporary considerations. There is also no increase in the quiescent current owing to the DC/DC converters. In addition, only one line is necessary for both voltages so that only a short circuit to earth can be inadvertently brought about.

A large number of controllers and sensors in motor vehicles must also be operated in a pulsed interrogation mode in the parked mode of the vehicle when the engine is off. In this non-operational mode they only have a small power drain and can be fed from the 36V battery without large losses. However, in the driving mode of the vehicle, the power drain increases drastically so that it is then necessary to supply only 7V operating voltage, which is then available from the generator operated by the engine.

In a development according to the invention, the decoupling device has a switch to whose first input a rectified low DC voltage acquired from the low AC voltage can be applied and to whose second input the high DC voltage can be applied, whose control input can be driven by an AC or DC voltage sensor connected either to the input or the output of the rectifier circuit and whose output makes available either the high or the low DC voltage.

The coupling or decoupling of the low AC voltage to and respectively from the high DC voltage can either take place capacitively or inductively, the capacitive coupling being preferred owing to lower losses. The coupling device and/or the decoupling device has an inductive coupling element, an inductive decoupling element, a capacitive coupling element, or a capacitive decoupling element.

Other features which are considered as characteristic for the invention are set forth in the appended claims.

Although the invention is illustrated and described herein as embodied in an electrical system architecture for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a vehicle electrical system architecture according to the invention; and

FIG. 2 is a block circuit diagram of a decoupling device according to the invention.

### DESCRIPTION OF THE PREFERRED EMBODIMENTS

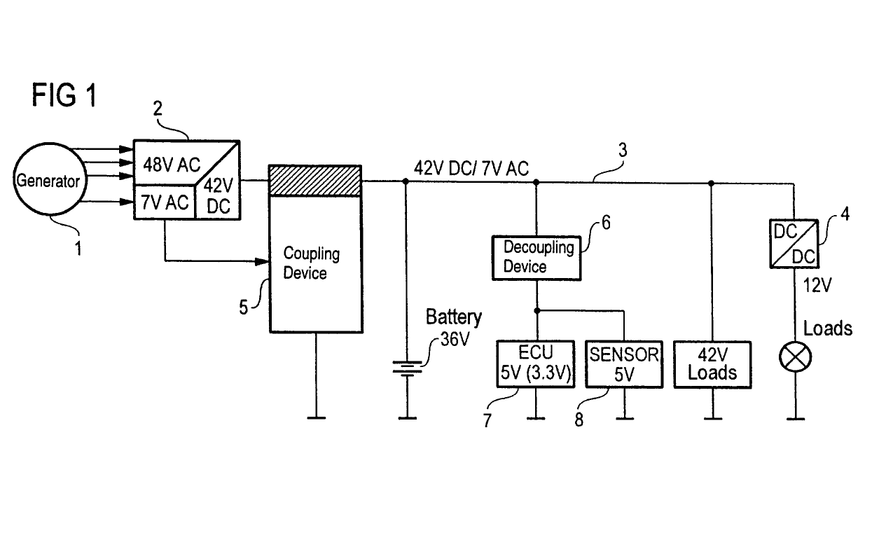

Referring now to the figures of the drawing in detail and first, particularly, to FIG. 1 thereof, there is shown a generator 1 which is powered by a motor vehicle engine. The generator 1 is an integrated starter generator in the exemplary embodiment illustrated and supplies a voltage processing unit 2 with a high AC voltage of 48V AC and a low AC voltage of 7V AC. The high AC voltage of 48V AC is rectified in the voltage processing unit 2 and transmitted as a high DC voltage of 42V DC on a high voltage line 3. The high voltage line 3 supplies power to various loads such as, for example, a 36V battery, 42V loads or 12V loads via a DC/DC converter 4.

In order to be able to supply even 5V or 3.3V loads via the line 3, according to the invention an inductive or capacitive coupling device 5 is connected to the high voltage line 3 which superimposes the low AC voltage of 7V AC made available by the voltage processing unit 2 onto the high DC voltage of 42V DC on the high voltage line 3.

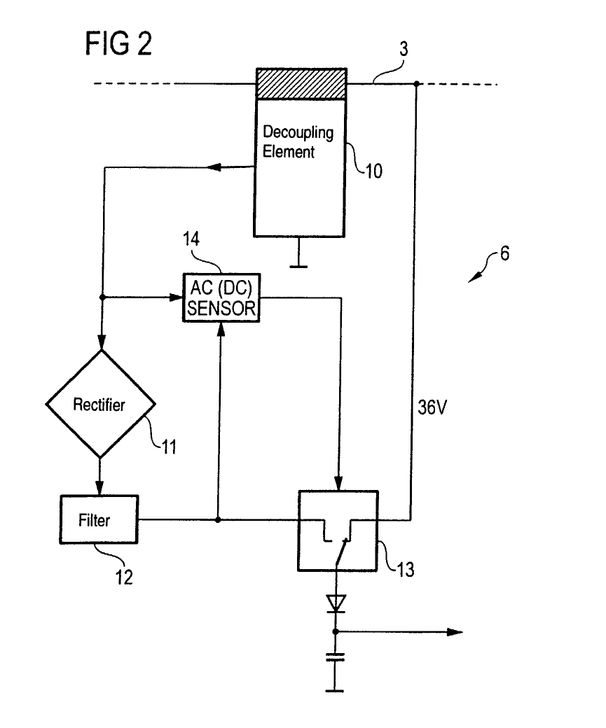

In order to decouple and rectify the 7V AC voltage, at least one decoupling device 6 is connected between the high voltage line 3 and 5V or 3.3V loads, for example electronic control units 7 or sensors 8. An exemplary embodiment of such a coupling device 6 is illustrated in FIG. 2 as a block circuit diagram.

Accordingly, the decoupling device 6 has a decoupling element 10 whose output is connected via a rectifier circuit 11 and an optional filter 12 to the first input of a switch 13. Via the switch 13, the rectified low AC voltage of 7V AC decoupled from the signal on the high voltage line 3 is fed to a linear voltage controller as a low DC voltage of 7V DC.

However, the low AC voltage of 7V AC is available only when the engine is running. There are, however, low-voltage loads that have to operate at least in an interrogation mode even when the engine is stationary, for example when a vehicle is parked. In the non-operational mode, the loads consume only a small amount of energy and can be supplied from the 36V battery without large losses. For this reason, a second input of the switch 13 is connected to the high voltage line 3 so that either the low DC voltage of 7V DC or the battery voltage of 36V is conducted via the switch 13.

Automatic activation of the switch 13 is carried out by a low-voltage sensor 14 which either detects the low AC voltage of 7V AC upstream of the rectifier 11 or the low DC voltage of 7V DC downstream of the rectifier 11, and activates the switch 13 in such a way that the low DC voltage is connected through. The optional sensing of the low AC or DC voltage is indicated by a continuous connecting line and a dashed connecting line.

In the exemplary embodiment in FIG. 1, the coupling of the low AC voltage of 7V AC to the high DC voltage of 42V on the high voltage line 3 is carried out by a special coupling device 5. However, it is also possible to provide the coupling device 5 as a component of the voltage processing unit 2.

I claim:

1. In a motor vehicle, an electrical system architecture, the electrical system architecture comprising:
a generator outputting a high AC voltage and at least one low AC voltage being lower than said high AC voltage;
a voltage processing unit connected to said generator and generating a high DC voltage from the high AC voltage;
a coupling device connected to said voltage processing unit and coupling the low AC voltage to the high DC voltage; and
a high voltage line extending from and fed by said coupling device, said high voltage line carrying the high DC voltage with the low AC voltage superimposed therewith.

2. The electrical system architecture according to claim 1, further comprising at least one decoupling device connected to said high voltage line, said decoupling device decouples the low AC voltage superimposed on the high DC voltage on said high voltage line, said decoupling device having a rectifier rectifying the low AC voltage resulting in a rectified low DC voltage being lower than said high DC voltage.

3. The electrical system architecture according to claim 2, wherein said decoupling device has a sensor coupled to said rectifier and a switch coupled to said rectifier, said switch having a first input receiving the rectified low DC voltage and a second input receiving a battery voltage, said switch having a control input driven by and connected to said sensor, said sensor connected to said rectifier circuit, said switch having an output which makes available either the high DC voltage or the low DC voltage.

4. The electrical system architecture according to claim 2, wherein at least one of said coupling device and said decoupling device has a device selected form the group consisting of inductive coupling elements, inductive decoupling elements, capacitive coupling elements, and capacitive decoupling elements.

5. The electrical system architecture according to claim 3, wherein said sensor is selected from the group consisting of AC voltage sensors and DC voltage sensors.
